(19) United States
(12) Patent Application Publication
(10) Pub. No.: US 2016/0078409 A1
(43) Pub. Date: Mar. 17, 2016

(54) AWAITER MANAGING SYSTEM, METHOD THEREFOR, AND AN APPARATUS APPLIED TO THE SAME

(71) Applicant: SK PLANET CO., LTD., Seongnam-si (KR)

(72) Inventors: Hyun Oh DOH, Seoul (KR); Jae Hyung HUH, Seongnam-si (KR)

(21) Appl. No.: 14/851,852

(22) Filed: Sep. 11, 2015

(30) Foreign Application Priority Data
Sep. 11, 2014 (KR) 10-2014-0120341

(51) Int. Cl. G06Q 10/10; H04W 4/02; H04W 4/00; G06Q 30/02

(52) U.S. Cl. CPC G06Q 10/1093; G06Q 30/0281; H04W 4/021; H04W 4/008

(57) ABSTRACT

The present invention discloses an awaiter managing system and a method therefore, and an apparatus applied to the same. That is, convenience for an awaiter waiting for a service usage can be improved by discriminating an actual awaiter terminal which is actually waiting for the service usage, among awaiter terminals to which waiting sequence numbers were issued, and providing guidance information until the waiting sequence number for the service usage is reached to the discriminated actual awaiter terminal.

### CROSS-REFERENCE TO RELATED APPLICATION

The instant application is based on and claims priority to Korean Patent Application No. 10-2014-0120341, filed on Sep. 11, 2014. The disclosure of above-listed application is hereby incorporated by reference herein in their entirety.

### BACKGROUND OF THE INVENTION

1. Field of the Invention

The present invention relates to a measure for discriminating an actual awaiter terminal which is actually waiting for the service usage, among awaiter terminals to which waiting sequence numbers were issued, and providing guidance information until the waiting sequence number for the service usage is reached to the discriminated actual awaiter terminal.

2. Description of the Related Art

According to conventional awaiter managing system used in banks or restaurants, it is not possible to predict how long the waiting time will be until a user's waiting sequence number is reached after the user's waiting sequence number was issued by way of a printout.

Recently, there is proposed a system for issuing the waiting sequence number to users who entered a waiting area based on a short-ranged wireless network, but this system can only provide a function of issuing the waiting sequence number or an alarming function.

Therefore, a new measure which can predict a waiting time till the service usage and provide the predicted result with the waiting sequence number as guidance information is needed.

### SUMMARY OF THE INVENTION

The present invention is conceived by considering the aforementioned situation, and the objective to be accomplished by the present invention is to improve convenience for an awaiter waiting for a service usage by discriminating an actual awaiter terminal which is actually waiting for the service usage, among awaiter terminals to which waiting sequence numbers were issued, and providing guidance information until the waiting sequence number for the service usage is reached to the discriminated actual awaiter terminal.

An awaiter managing device to accomplish the objective according to an aspect of the present invention is characterized in comprising: an issuing unit which issues waiting sequence numbers according to a waiting request sequence to awaiter terminals which have entered a waiting area and been requested to wait for a service usage; a discriminating unit which discriminates an actual awaiter terminal which is actually waiting for the service usage among the awaiter terminals to which the waiting sequence numbers were issued; and a providing unit which, for the discriminated actual awaiter terminal, generates and provides guidance information related to the wait for the service usage until the waiting sequence number for the service usage is reached.

An operating method for the awaiter managing device to accomplish the objective according to an aspect of the present invention is characterized in comprising: an issuing step which issues waiting sequence numbers according to a waiting request sequence to awaiter terminals which have entered a waiting area and been requested to wait for a service usage; a discriminating step which discriminates an actual awaiter terminal which is actually waiting for the service usage among the awaiter terminals to which the waiting sequence numbers were issued; and a providing step which, for the discriminated actual awaiter terminal, generates and provides guidance information related to the wait for the service usage until the waiting sequence number for the service usage is reached.

A program stored on a medium to accomplish the objective according to an aspect of the present invention is characterized in executing: an issuing step which issues waiting sequence numbers according to a waiting request sequence to awaiter terminals which have entered a waiting area and been requested to wait for a service usage; a discriminating step which discriminates an actual awaiter terminal which is actually waiting for the service usage among the awaiter terminals to which the waiting sequence numbers were issued; and a providing step which, for the discriminated actual awaiter terminal, generates and provides guidance information related to the wait for the service usage until the waiting sequence number for the service usage is reached.

Therefore, according to the awaiter managing system, a method therefor, and an apparatus applied to the same, convenience for an awaiter waiting for a service usage can be improved by discriminating an actual awaiter terminal which is actually waiting for the service usage, among awaiter terminals to which waiting sequence numbers were issued, and providing guidance information until the waiting sequence number for the service usage is reached to the discriminated actual awaiter terminal.

### BRIEF DESCRIPTION OF THE DRAWINGS

FIG. 1 is a schematic configuration diagram of an awaiter managing system according to an embodiment of the present invention;

FIG. 2 is a schematic configuration diagram of an awaiter managing device according to the fourth embodiment of the present invention;

FIG. 3 is a schematic flowchart for illustrating an operation flow in the awaiter managing system according to an embodiment of the present invention; and

FIG. 4 is a schematic flowchart for illustrating an operation flow of the awaiter managing device according to the first embodiment of the present invention.

### DETAILED DESCRIPTION OF THE INVENTION

Technical terms used herein are used merely for illustrating specific embodiments, and it is to be noted that they are not intended to limit technical spirit disclosed in this specification. Also, the technical terms used herein are to be construed by the meanings normally accepted by the person having ordinary skill in the relevant art, unless specifically defined by other meanings in this specification, and it is neither to be construed by excessively comprehensive meanings nor excessively narrow meanings. Also, when the technical terms used herein are determined to be wrong technical terms which fail to represent the technical spirit disclosed in this specification correctly, the terms are to be replaced by the technical terms which can be accurately understood by the person having ordinary skill in the art. Also, the general terms used in this specification are to be construed as defined in the dictionaries or according to context, and they are not to be construed in an excessively narrow meaning.

Also, the singular representation used in this specification includes plural representations unless it is clearly expressed in the context to the contrary. The terms “include” or “is composed of” in this specification are not to be construed to necessarily include all components and all steps cited in this specification, and it should be construed to exclude some components or some steps or further include additional components and steps.

Also, the terms representing an ordinal number such as first, second, etc. used in this specification can be used to explain various components, however, the components are not to be limited by these terms. These terms are used only for discriminate one component from other components. For example, the first component can be entitled as a second component, and similarly, the second component can be entitled as the first component, without departing from the technical scope of the present invention.

In the following, embodiments disclosed in this specification are to be described in detail by referring to the appended figures, wherein the same reference numerals are given to the same or like components irrespective of the number of the figures, and duplicate description on them will be omitted.

Also, when it is determined that a detailed description on a relevant known art will obscure the subject matter disclosed in the specification while describing the technologies disclosed in this specification, the detailed description will be omitted. Also, it is to be noted that the appended figures are only for facilitating the technical spirit disclosed in this specification and the technical spirit are not to be construed to be limited by the appended figures.

Here, one embodiment of the present invention is described by referring to the appended figures.

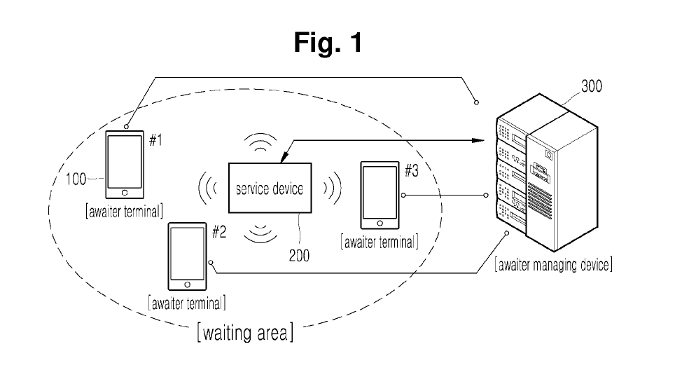

FIG. 1 is diagram illustrating an awaiter managing system according to an embodiment of the present invention.

As shown in FIG. 1, the awaiter managing system according to an embodiment of the present invention has a configuration including: an awaiter terminal 100, a service device 200 which processes actual service usage of the awaiter terminal 100, and an awaiter managing device 300 which provides guidance information related to the waiting of the awaiter terminal 100 for the service usage.

With the awaiter managing system according to an embodiment of the present invention, the guidance information is provided after it is acknowledged that the awaiter terminal 100 has entered a waiting area which is formed in relation to the service usage.

This waiting area can refer to a coverage which is formed based on a short-range wireless communication signal such as Bluetooth low energy (BLE) signal, a WI-FI signal, and a sound beacon signal.

Therefore, the awaiter managing system according to an embodiment of the present invention can have a configuration which further includes a signal transmitting device (not shown) which transmits a short-range wireless communication signal (‘proximal signal’, hereinafter) in order to form the waiting area.

This signal transmitting device can exist in the system as a separate device, however, in the embodiment of the present invention, it is described as existing in a form integrated with the service device 200 for the convenience of explanation.

The awaiter terminal 100 refers to a mobile device which can receive and display the guidance information related to the wait for the service usage from the awaiter managing device 300, after the mobile device entered the waiting area.

For example, awaiter terminal 100 can be a smart phone, a tablet PC, and a personal digital assistant (PDA), but it is not limited to these and it can encompass all devices which can receive the proximal signal forming the waiting area, and receive and display the guidance information.

The service device 200 refers to a device which processes the service usage for the awaiter terminal 100 which, in an off-line space (e.g.: banks, restaurants, and hospitals), has been given the waiting sequence number from the awaiter managing device 300 and to which the waiting sequence number has been issued.

For example, a POS, a personal computer (PC), a kiosk, etc. can be included in the terminal device 200, and the terminal device 100 is not limited to these, and can include all devices which can be linked to the awaiter managing device 300.

The awaiter managing device 300 refers to a server for issuing the waiting sequence number to the awaiter terminal 100 which has entered the waiting area, and providing the guidance information related to the wait for the service usage of the awaiter terminal 100.

Meanwhile, according to an embodiment of the present invention, there is proposed an awaiter managing system which issues the waiting sequence number to the awaiter terminal 100 which has entered the waiting area such that the awaiter terminals 100 can use the service according to the issued waiting sequence number.

By the way, as for the conventional awaiter managing systems, they just provide a function of issuing the waiting sequence numbers and an alarm function for notifying that the waiting sequence number is reached.

As a result, there exists a drawback in the conventional awaiter managing system that it is not possible to predict how long the waiting time will be until a users waiting sequence number is reached after the user's waiting sequence number was issued.

Therefore, since it is not possible to predict the estimated waiting time after the issuance of the waiting sequence number, when the awaiter leaves and returns to the waiting area, it can happen that the awaiter's waiting sequence number has passed and the awaiter have to have the waiting sequence number reissued, and inconvenience is evidently expected.

Therefore, one embodiment of the present invention proposes a measure for improving convenience for the awaiter carrying the awaiter terminal 100 by providing guidance information related to the wait for the service usage, and this measure will be explained in detail in the following.

The awaiter terminal 100 performs a function of accepting a request that it should wait for a service usage.

More specifically, when the awaiter terminal 100 enters the waiting area, the awaiter managing device 300 requests it to wait for the service usage, and the awaiter managing device 300 issues a waiting sequence number according to the waiting request sequence to the awaiter terminal.

Here, a near field communication (NFC) or a quick response (QR) code having coded connection information with the awaiter managing device 300, etc. can be arranged in an off-line space where the waiting area is formed.

Therefore, when entering the waiting area, the recognizes the NFC or the QR code arranged in the waiting space area, and the has the waiting sequence number for the service usage issued from the awaiter managing device 300.

For reference, when the awaiter terminal 100 recognizes the NFC or QR code, an application, which is installed in relation to the wait for the service usage, is automatically executed, and the awaiter terminal 100 can have the waiting sequence number issued from the awaiter managing device 300 through this application being executed.

The service device 200 performs a function of processing the service usage for the awaiter terminal 100.

More specifically, when the service usage is processed for the awaiter terminal 100, the service device 200 receives a guidance for the waiting sequence number, whose service usage sequence is reached, from the awaiter managing device 300, and the service usage is processed for the awaiter terminal 100 to which the guided waiting sequence number was issued.

In connection with this, when the service usage processing for the awaiter terminal 100 to which a specific waiting sequence number was issued is completed, the service device 200 sends a request for the guidance of the next waiting sequence number to the awaiter managing device 300, and then receives the guidance.

Meanwhile, when the service usage processing for the awaiter of the waiting sequence number guided from the service device 200 is not performed, the service device 200 notifies of this to the awaiter managing device 300, such that the awaiter managing device 300 can delete or reissue the waiting sequence number which was issued for the notified awaiter terminal 100.

Here, for the cases when the service usage processing is not performed, a case when the awaiter, to which the waiting sequence number has been issued, loses the intention to use the service, or a case when the awaiter terminal leaves the waiting area can be predicted.

The awaiter managing device 300 performs a function of issuing the waiting sequence number.

More specifically, the awaiter managing device 300 issues the waiting sequence number according to a waiting request sequence, for the awaiter terminals 100 which entered the waiting area and were requested to wait for the service usage.

Also, the awaiter managing device 300 performs a function of discriminating the actual awaiter terminals.

More specifically, the awaiter managing device 300 discriminates, among all of the awaiter terminals 100 to which the waiting sequence numbers were issued, the awaiter terminal which is actually waiting for the service usage as the actual awaiter terminal.

In the meantime, in relation to the discrimination of the actual awaiter terminal, the awaiter managing device 300 discriminates, among the awaiter terminals 100 to which the waiting sequence numbers were issued, the awaiter terminals 100 which are acknowledged to exist in the waiting area, or which, even when acknowledged to have left the waiting area, are still acknowledged to have the intention to wait for the service usage as the actual awaiter terminal.

The control unit 300 performs a function of providing the guidance information.

More specifically, when the discrimination for the actual awaiter terminals are completed, the awaiter managing device 300 generates and provides the guidance information which is related to the wait for the service usage, for the awaiter terminals 100 which are discriminated as the actual awaiter terminals.

In the meantime, the awaiter managing device 300 generates and provides, for each of the awaiter terminals 100 which is discriminated to be the actual awaiter terminal, a notification message for informing that the waiting sequence number for the service usage is reached, and predicts and provides the expected waiting time from the current time instant to when the waiting sequence number of the terminal is reached, before providing the notification message.

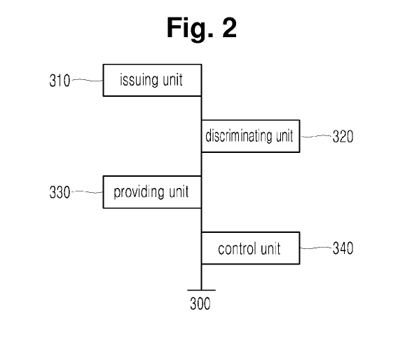

In the following, the configuration of the awaiter managing device 300 according to an embodiment of the present invention will be explained in detail by referring to FIG. 2.

That is, the awaiter managing device 300 according to an embodiment of the present invention can have the configuration including an issuing unit 310 which issues the waiting sequence number, a discriminating unit 320 which discriminates the actual awaiter terminal, and a providing unit 330 which provides the guidance information.

Also, the awaiter managing device 300 according to an embodiment of the present invention can have the configuration which, in addition to the aforementioned configuration, further includes a control unit 340 which controls the issuance of the waiting sequence number.

Here, all or a part of the aforementioned configuration of the awaiter managing device 300 including the issuing unit 310, discriminating unit 320, providing unit 330, and the control unit 340 can be implemented as a software module executed by a processor or as a combination of the software module and a hardware.

The issuing unit 310 performs a function of issuing the waiting sequence number.

More specifically, when the awaiter terminals 100 which have entered the waiting area are requested to wait for the service usage, the issuing unit 310 issues the waiting sequence number according to the waiting request sequence, for each of the awaiter terminals 100.

In connection with this, after entering the waiting area, the awaiter terminal 100 can recognize the NFC or the QR code arranged in the waiting area and can be requested to wait for the service usage.

The discriminating unit 320 performs a function of discriminating the actual awaiter terminals.

More specifically, the discriminating unit 320 discriminates, among all of the awaiter terminals 100 to which the waiting sequence numbers were issued, the awaiter terminal which is actually waiting for the service usage as the actual awaiter terminal.

The discrimination on the actual awaiter terminal among the awaiter terminals 100 to which the waiting sequence numbers were issued is performed to discriminate the awaiter terminals 100 which, after the waiting sequence numbers for waiting for the service usage were issued, do not have the intention to use the service any longer or cannot use the service since they left the waiting area.

In the meantime, the discriminating unit 320 discriminates the actual awaiter terminal by acknowledging whether the awaiter terminal 100, to which the waiting sequence number was issued, has left the waiting area.

Here, whether the awaiter terminal 100 has left the waiting area can be acknowledged as follows.

That is, when the awaiter terminal 100 enters the waiting area, it periodically receives the proximal signal transmitted from the service device 200, and can acknowledge that it is currently located in the waiting area.

When, the awaiter terminal 100 cannot receive the proximal signal for a set time period, it recognizes that its current location is out of the waiting area, and then it can inform that it has left the waiting area to the awaiter managing device 300, such that the awaiter managing device 300 can acknowledge that the awaiter terminal 100 has left the waiting area.

Meanwhile, when the proximal signal is received again after the awaiter terminal 100 has left the waiting area, and it is recognized that it has come back to the waiting area, the return state of the terminal to the waiting area is notified to the awaiter managing device 300, such that the awaiter managing device 300 can acknowledge that the awaiter terminal 100, which has left the waiting area, came back to the waiting area.

As a result, in relation to the discrimination of the actual awaiter terminal, the discriminating unit 320 discriminates, among the awaiter terminals 100 to which the waiting sequence numbers were issued, the awaiter terminals 100 which are acknowledged to exist in the waiting area, or which, even when acknowledged to have left the waiting area, are still acknowledged to have the intention to wait for the service usage as the actual awaiter terminal.

Here, the actual awaiter terminal can be acknowledged based on the warning message which issues a warning that the awaiter terminal 100 has left the waiting area, to the terminal which has left the waiting area.

Therefore, when it is acknowledged that the awaiter terminal 100 has left the waiting area, the discriminating unit 320 enables the providing unit 330 to provide the warning message informing the leave from the waiting area to the corresponding awaiter terminal 100, and it acknowledges that the awaiter terminal 100 has the intention to wait for the service usage only when a response message to the warning message is received from the awaiter terminal 100, which has left the waiting area, within a set time period, after a time instant when the warning message was provided.

In the meantime, when the response message to the warning message is not received from the awaiter terminal 100, which has left the waiting area, within the set time period, the awaiter terminal 100 is apparently removed from an actual awaiter terminal list.

The providing unit 330 performs a function of providing the guidance information.

More specifically, when the discrimination for the actual awaiter terminals are completed, the providing unit 330 generates and provides the guidance information which is related to the wait for the service usage, for the awaiter terminals 100 which are discriminated as the actual awaiter terminals.

Here, the guidance information related to the wait for the service usage can include a notification message for informing that its waiting sequence number for the service usage has reached, and the expected waiting time which is the time expected to elapse until the time instant when its waiting sequence number is reached.

Therefore, the providing unit 330 generates and provides, for each of the awaiter terminals 100 which is discriminated to be the actual awaiter terminal, a notification message for informing that the waiting sequence number for the service usage is reached, and predicts and provides the expected waiting time from the current time instant to when the waiting sequence number of the terminal is reached, before providing the notification message.

In the meantime, the expected waiting time can be predicted based on the number of actual awaiter terminals which are waiting for the service usage with respect to the number of actual awaiter terminals which have completed the service usage for a specified reference time period (e.g.: 5 minutes, 10 minutes).

For example, when it is assumed that the number of the actual awaiter terminals which have completed the service usage for 5 minutes is 10 and the number of actual awaiter terminals which are waiting for the service usage is 100, the expected waiting time of the actual awaiter terminal to which the last waiting sequence number was issued can be predicted to be 50 minutes.

As noted above, when the notification message is generated and provided for the awaiter terminal 100 which is discriminated as the actual awaiter terminal, it means that the service usage sequence for the awaiter terminal 100 which receives the notification message is reached.

Therefore, the notification message generation operation performed in the providing unit 330 can be performed when the awaiter terminal 100 which receives the notification message requests the service device 200 to inform about the waiting sequence number.

The issuing unit 340 performs a function of controlling the issuance of the waiting sequence numbers.

More specifically, when it is acknowledged from the service device 200 that the service usage is not realized for a specific awaiter terminal 100, which was discriminated as the actual awaiter terminal even after its waiting sequence number is reached, or when re-entrance to the waiting area after leaving it is not acknowledged, the control unit 340 controls the issuing unit 310 to delete or reissue the issued waiting sequence number.

As described in the above, by using the awaiter managing system according to an embodiment of the present invention awaiter managing system, there are provided the awaiter managing system, a method therefor, and an apparatus applied to the same, and the convenience for an awaiter waiting for the service usage can be improved by discriminating an actual awaiter terminal which is actually waiting for the service usage, among awaiter terminals to which waiting sequence numbers were issued, generating the notification message for informing the waiting sequence number for the actual awaiter terminal is reached, predicting the expected waiting time until the waiting sequence number for the service usage is reached, and providing the notification message and the expected waiting time as guidance information.

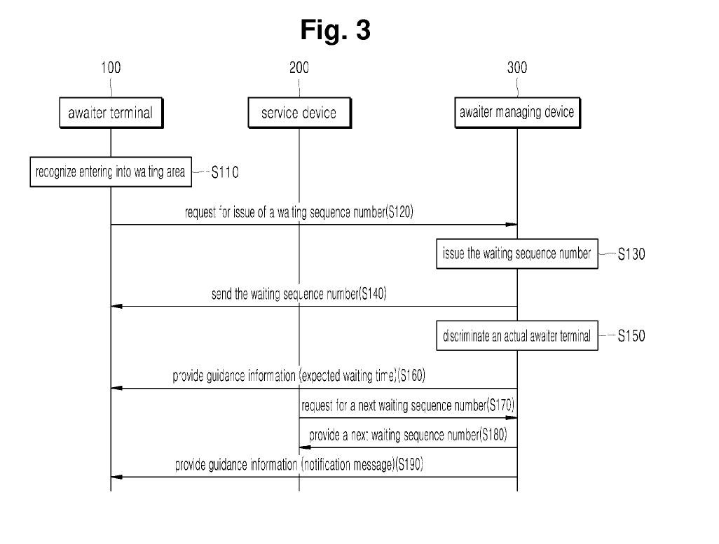

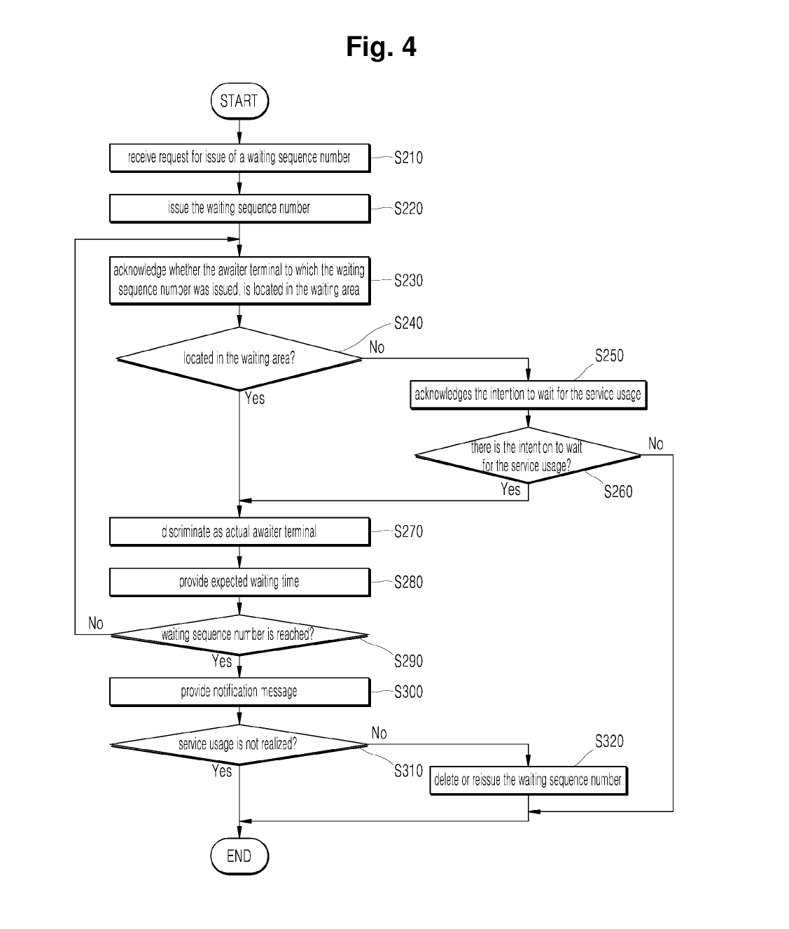

In the following, the awaiter managing method according to an embodiment of the present invention will be explained by referring to FIGS. 3 and 4. Here, the configurations described in the FIG. 1 and FIG. 2 are referred to by using corresponding reference numbers for the convenience of description.

At first, the operation flow in the awaiter managing system according to an embodiment of the present invention will be explained by referring to FIG. 3.

Initially, when the awaiter terminal 100 enters the waiting area, the awaiter managing device 300 requests it to wait for the service usage, and the awaiter managing device 300 issues a waiting sequence number according to the waiting request sequence to the awaiter terminal (S110-S120).

In the meantime, after entering the waiting area, the awaiter terminal 100 can recognize the NFC or the QR code arranged in the waiting area and can be requested to wait for the service usage.

Then, the awaiter managing device 300 issues the waiting sequence number according to the waiting request sequence, for the awaiter terminals 100 which have entered the waiting area and were requested to wait for the service usage.

Then, the awaiter managing device 300 discriminates, among all of the awaiter terminals 100 to which the waiting sequence numbers were issued, the awaiter terminal which is actually waiting for the service usage as the actual awaiter terminal (S150).

In the meantime, in relation to the discrimination of the actual awaiter terminal, the awaiter managing device 300 discriminates, among the awaiter terminals 100 to which the waiting sequence numbers were issued, the awaiter terminals 100 which are acknowledged to exist in the waiting area, or which, even when acknowledged to have left the waiting area, are still acknowledged to have the intention to wait for the service usage as the actual awaiter terminal.

Next, the awaiter managing device 300 predicts, for each of the awaiter terminals 100 which was discriminated as the actual awaiter terminal, the expected waiting time until its waiting sequence number is reached, and provides this as the guidance information (S160).

Meanwhile, when the service usage is processed for the awaiter terminal 100, the service device 200 receives a guidance for the waiting sequence number, whose service usage sequence is reached, from the awaiter managing device 300, and the service usage is processed for the awaiter terminal 100 to which the guided waiting sequence number was issued.

In the meantime, when the waiting sequence number is reached for each of the awaiter terminals 100 which was discriminated as the actual awaiter terminal, the awaiter managing device 300 generates the notification message for notifying this and provides this notification message as the guidance information (S190).

In the following, the operation of the awaiter managing device 300 according to an embodiment of the present invention will be explained in detail by referring to FIG. 4.

At first, when the awaiter terminals 100 which have entered the waiting area are requested to wait for the service usage, the issuing unit 310 issues the waiting sequence number according to the waiting request sequence, for each of the awaiter terminals 100 (S210-S220).

In connection with this, after entering the waiting area, the awaiter terminal 100 can recognize the NFC or the QR code arranged in the waiting area and can be requested to wait for the service usage.

Then, in order to discriminate the actual awaiter terminal which are actually waiting for the service usage among all of the awaiter terminals 100 to which the waiting sequence numbers were issued, the discriminating unit 320 acknowledges whether the awaiter terminal 100, to which the waiting sequence number was issued, is located in the waiting area (S230).

In the meantime, when it is acknowledged that the awaiter terminal 100, to which the waiting sequence number was issued, exists in the waiting area, the discriminating unit 320 discriminates the corresponding awaiter terminal 100 as an actual awaiter terminal (S240, S270).

In connection with this, the awaiter terminal 100, to which the waiting sequence number was issued, receives a proximal signal in the waiting area, and, when, the awaiter terminal 100 cannot receive the proximal signal for a set time period, it comes to recognize that its current location is out of the waiting area, and then it can inform that it has left the waiting area to the awaiter managing device 300, such that the awaiter managing device 300 can acknowledge that the awaiter terminal 100 has left the waiting area.

Meanwhile, even when it is acknowledged that the awaiter terminal 100, to which the waiting sequence number was issued, has left the waiting area, the discriminating unit 320 can still discriminate the awaiter terminal as the actual awaiter terminal when the awaiter terminal is acknowledged to have the intention to wait for the service usage. (S240, S270).

In the meantime, when it is acknowledged that the awaiter terminal 100 has left the waiting area, the discriminating unit 320 enables the providing unit 330 to provide the warning message informing the leave from the waiting area to the corresponding awaiter terminal 100, and it acknowledges that the awaiter terminal 100 has the intention to wait for the service usage only when a response message to the warning message is received from the awaiter terminal 100, which has left the waiting area, within a set time period, after a time instant when the warning message was provided.

Next, when the discrimination on the actual awaiter terminals is completed, the providing unit 330 predicts, for each of the awaiter terminals 100 which was discriminated as the actual awaiter terminals, the expected waiting time until its waiting sequence number is reached, and provides this as the guidance information (S280).

In the meantime, the providing unit 330 can predict the expected waiting time based on the number of actual awaiter terminals which are waiting for the service usage with respect to the number of actual awaiter terminals which have completed the service usage for a specified reference time period (e.g.: 5 minutes, 10 minutes).

For example, when it is assumed that the number of the actual awaiter terminals which have completed the service usage for 5 minutes is 10 and the number of actual awaiter terminals which are waiting for the service usage is 100, the expected waiting time of the actual awaiter terminal to which the last waiting sequence number was issued can be predicted to be 50 minutes.

Then, when the waiting sequence number is reached for each of the awaiter terminals 100 which was discriminated as the actual awaiter terminal, the providing unit 330 generates the notification message for notifying this and provides this notification message as the guidance information (S290-S300).

By the way, when it is acknowledged from the service device 200 that the service usage is not realized for a specific awaiter terminal 100, which was discriminated as the actual awaiter terminal even after its waiting sequence number is reached, or when re-entrance to the waiting area after leaving it is not acknowledged, the control unit 340 controls the issuing unit 310 to delete or reissue the issued waiting sequence number (S310-S320).

As described in the above, by using the awaiter managing method according to an embodiment of the present invention awaiter managing system, there are provided the awaiter managing system, a method therefor, and an apparatus applied to the same, and the convenience for an awaiter waiting for the service usage can be improved by discriminating an actual awaiter terminal which is actually waiting for the service usage, among awaiter terminals to which waiting sequence numbers were issued, generating the notification message for informing the waiting sequence number for the actual awaiter terminal is reached, predicting the expected waiting time until the waiting sequence number for the service usage is reached, and providing the notification message and the expected waiting time as guidance information.

Meanwhile, the realized articles of functional operations and subject matters described in this specification can be implemented using digital electronic circuits, or implemented as computer software, firmware, or hardware including the configuration disclosed in this specification and structural equivalents thereof, or as a combination be at least one of these implementations. The articles of realization of the subject matter described in this specification can be implemented as one or more computer program product, that is, one or more module related to computer program instructions which are encoded on a tangible program storage medium for controlling the operation of the process system or for being executed by the same.

The computer-readable medium can be a machine-readable storage device, a machine-readable storage board, a memory device, a composition of materials affecting machine-readable wave signals, and a combination of at least one of them.

The term such as “a system” or “a device” in this specification encompasses all tools, devices, and machines for processing data including, for example, a programmable processor, a computer, or a multi-processor. The process system can include a code for creating an execution atmosphere for the computer program, when requested by a code constituting a processor firmware, a protocol stack, a database management system, an operating system, or a combination of at least one of them, etc., in addition to a hardware.

The computer (also known as a program, a software, a software application, a script, or a code) can be created in all types of program languages including a compiled or interpreted language or a priori or procedural language, and can be arranged in all types including standalone programs, modules, subroutines, and other units proper to be used in a computing environment. The computer program does not necessarily correspond to a file of a file system. The program can be stored in a single file provided by the requested program, in multiple files which interact with each other (for example, files storing one or more module, low level programs or some of the code), or in a part of the file containing other programs or data (for example, one or more script stored in a markup language document). The computer program can be arranged to be positioned in one site or distributed over a plurality of sites, such that it can be executed on multiple computers interconnected via a communication network or on a single computer.

Meanwhile, the computer-readable medium which is proper for storing computer program instructions and data can include and all types of nonvolatile memories, media, and memory devices including a semiconductor memory device such as EPROM, EEPROM and flash memory device, a magnetic disk such as internal hard disk or removable disk, optical disk, a CD-ROM and a DVD-ROM disk. The processor and the memory can be supplemented by a special purpose logic circuit or integrated into the same.

The article of realization of the subject matter described in this specification can include a back-end component such as a data server, a middleware component such as an application server, or a front-end component such as a client computer having a web browser or a graphic user interface which enables a user to interact with the article of realization of the subject matter described in this specification, or can implement all combinations of these back-end, middleware, or front-end components in a computing system. The components of a system can be interconnected with each other by all types or media of digital data communication such as a communication network.

Although this specification includes details of various specific implementations, it is not to be understood as limiting for all inventions or scope to be claimed, and it should rather be understood as an explanation for the features which can be unique to specific implementations of the specific invention. Similarly, the specific features described in this specification in the context of separate implementations can be implemented to be combined in a single implementation. On the contrary, various features described in the context of the single implementation can also be implemented as discrete or proper low level combinations as well as in various implementations. Furthermore, although the features can be depicted as work in a specific combination and as claimed in the first place, one or more features from the claimed combination can be excluded from the combination in some cases, and the claimed combination can be changed to the low level combinations or subcombinations.

Also, although this specification depicts the operations in a specific order in the drawings, it is not to be understood that this specific sequence or order should be maintained or all the shown operations should be performed in order to obtain the preferred results In specific cases, multitasking and parallel processing can be preferable. Also, the division of various system components of the aforementioned embodiments are not to be construed as being required by all embodiments, and it is to be understood that the described program components and systems can generally be unified into a single software product or packaged in multiple software products.

Similarly, this specification is not intended to limit the present invention to specific terms provided. Therefore, although the present invention has been explained in detail by referring to the aforementioned examples, it is possible for the person having ordinary skill in the art to alter, change, or modify these examples without departing from the scope of the present invention. The scope of the present invention is expressed by the claims, not by the specification, and all changes and modified shapes derived from the meanings of the claims, scopes, and the equivalents thereof are construed to be included in the scope of the present invention.

What is claimed is:

1. An awaiter managing device comprising:
an issuing unit which issues waiting sequence numbers according to a waiting request sequence to awaiter terminals which have entered a waiting area and been requested to wait for a service usage;
a discriminating unit which discriminates an actual awaiter terminal which is actually waiting for the service usage among the awaiter terminals to which the waiting sequence numbers were issued; and
a providing unit which, for the discriminated actual awaiter terminal, generates and provides guidance information related to the wait for the service usage until the waiting sequence number for the service usage is reached.

2. The awaiter managing device of claim 1, characterized in that the actual awaiter terminal is discriminated based on whether the awaiter terminal to which the waiting sequence number was issued has left the waiting area, and
the discriminating unit discriminates, among the awaiter terminals to which the waiting sequence numbers were issued, the awaiter terminal which is acknowledged to exist in the waiting area, or which, even when acknowledged to have left the waiting area, is still acknowledged to have the intention to wait for the service usage as the actual awaiter terminal.

3. The awaiter managing device of claim 2, characterized in that the intention to wait for the service usage is acknowledged based on a warning message to warn about the leave from the waiting area, and
the discriminating unit enables the providing unit to provide the warning message to a specific awaiter terminal, when the specific awaiter terminal, to which the waiting sequence number was issued, is acknowledged to have left the waiting area, and acknowledges that the specific awaiter terminal has the intentional to wait for the service usage, when it is acknowledged that a response message to the warning message is received from the specific awaiter terminal.

4. The awaiter managing device of claim 1, characterized in that at least one of a notification message for announcing that the waiting sequence number for the service usage is reached and an expected waiting time which is predicted to elapse until the waiting sequence number for the service usage is reached is included in the guidance information.

5. The awaiter managing device of claim 4, characterized in that the expected waiting time is predicted based on the number of actual awaiter terminals which are waiting for the service usage with respect to the number of actual awaiter terminals which have completed the service usage for a specified reference time period.

6. The awaiter managing device of claim 2, characterized in that the awaiter managing device further comprises a control unit which controls to delete or reissue the issued waiting sequence number for, among the actual awaiter terminals, the actual awaiter terminal which has not used the service even after the waiting sequence number for the service usage was reached, or which is not acknowledged to re-enter the waiting area after having left the waiting area.

7. An operating method for an awaiter managing device comprising:
an issuing step which issues waiting sequence numbers according to a waiting request sequence to awaiter terminals which have entered a waiting area and been requested to wait for a service usage;
a discriminating step which discriminates an actual awaiter terminal which is actually waiting for the service usage among the awaiter terminals to which the waiting sequence numbers were issued; and
a providing step which, for the discriminated actual awaiter terminal, generates and provides guidance information related to the wait for the service usage until the waiting sequence number for the service usage is reached.

8. The operating method of claim 7, characterized in that the actual awaiter terminal is discriminated based on whether the awaiter terminal to which the waiting sequence number was issued has left the waiting area, and
the discriminating step discriminates, among the awaiter terminals to which the waiting sequence numbers were issued, the awaiter terminal which is acknowledged to exist in the waiting area, or which, even when acknowledged to have left the waiting area, is still acknowledged to have the intention to wait for the service usage as the actual awaiter terminal.

9. The operating method of claim 8, characterized in that the intention to wait for the service usage is acknowledged based on a warning message to warn about the leave from the waiting area, and
the discriminating step enables a providing unit to provide the warning message to a specific awaiter terminal, when the specific awaiter terminal, to which the waiting sequence number was issued, is acknowledged to have left the waiting area, and acknowledges that the specific awaiter terminal has the intentional to wait for the service usage, when it is acknowledged that a response message to the warning message is received from the specific awaiter terminal.

10. The operating method of claim 7, characterized in that at least one of a notification message for announcing that the waiting sequence number for the service usage is reached and an expected waiting time which is predicted to elapse until the waiting sequence number for the service usage is reached is included in the guidance information.

11. The operating method of claim 10, characterized in that the expected waiting time is predicted based on the number of actual awaiter terminals which are waiting for the service usage with respect to the number of actual awaiter terminals which have completed the service usage for a specified reference time period.

12. The operating method of claim 8, characterized in that the operating method further comprises, after the providing step, a control step which controls to delete or reissue the issued waiting sequence number for, among the actual awaiter terminals, the actual awaiter terminal which has not used the service even after the waiting sequence number for the service usage is reached, or which are not acknowledged to re-enter the waiting area after having left the waiting area.

13. A program stored on a medium for executing:
an issuing step which issues waiting sequence numbers according to a waiting request sequence to awaiter terminals which have entered a waiting area and been requested to wait for a service usage;
a discriminating step which discriminates an actual awaiter terminal which is actually waiting for the service usage among the awaiter terminals to which the waiting sequence numbers were issued; and
a providing step which, for the discriminated actual awaiter terminal, generates and provides guidance information related to the wait for the service usage until the waiting sequence number for the service usage is reached.
